(19) United States
(12) Patent Application Publication
(10) Pub. No.: US 2013/0173884 A1
(43) Pub. Date: Jul. 4, 2013

(54) PROGRAMMABLE DEVICE FOR SOFTWARE DEFINED RADIO TERMINAL

(71) Applicants: Imec, Leuven (BE); Samsung Electronics, Suwon-si (KR)

(72) Inventors: Bruno Bougard, Jodoigne (BE); Thomas Schuster, Braunschweig (DE)

(73) Assignees: Samsung Electronics, Suwon-si (KR); Imec, Leuven (BE)

(21) Appl. No.: 13/708,857

(22) Filed: Dec. 7, 2012

Related U.S. Application Data
(63) Continuation of application No. 12/641,035, filed on Dec. 17, 2009, now abandoned.
Application No. 12/641,035 is a continuation of application No. PCT/EP2007/061220, filed on Oct. 19, 2007.

(30) Foreign Application Priority Data
Jun. 18, 2007 (EP) EP 07110493.9

(51) Int. Cl. G06F 15/76

(52) U.S. Cl. CPC G06F 15/76
USPC 712/3

(57) ABSTRACT

A programmable device suitable for software defined radio terminal is disclosed. In one aspect, the device includes a scalar cluster providing a scalar data path and a scalar register file and arranged for executing scalar instructions. The device may further include at least two interconnected vector clusters connected with the scalar cluster. Each of the at least two vector clusters provides a vector data path and a vector register file and is arranged for executing at least one vector instruction different from vector instructions performed by any other vector cluster of the at least two vector clusters.

### CROSS REFERENCE TO RELATED APPLICATIONS

This application is a continuation of U.S. patent application Ser. No. 12/641,035, filed Dec. 17, 2009, titled “PROGRAMMABLE DEVICE FOR SOFTWARE DEFINED RADIO TERMINAL”, which application is a continuation of PCT Application No. PCT/EP2007/061220, filed Oct. 19, 2007. Each of the above applications is incorporated by reference hereby in its entirety.

### BACKGROUND OF THE INVENTION

1. Field of the Invention

The present invention relates to a digital programmable device suitable for use in a software-defined radio platform, more in particular for functionalities having a high duty cycle and relaxed, but not zero, requirements in programmability.

2. Description of the Related Technology

Software-defined radio (SDR) is a collection of hardware and software technologies that enable reconfigurable system architectures for wireless networks and user terminals. SDR provides an efficient and comparatively inexpensive solution to the problem of building multi-mode, multi-band, multi-functional wireless devices that can be adapted, updated or enhanced by using software upgrades. As such, SDR can be considered an enabling technology that is applicable across a wide range of areas within the wireless community.

The continuously growing variety of wireless standards and the increasing costs related to IC design and handset integration make implementation of wireless standards on such reconfigurable radio platforms the only viable option in the near future. With platform is meant the framework on which applications may be run. SDR is an effective way to provide the performance and flexibility necessary therefore.

If programmable from a high-level language (such as C), SDR enables cost effective multi-mode terminals but still suffers from a significant energy penalty as compared to dedicated hardware solutions. Hence, programmability and energy efficiency must be carefully balanced. To maintain energy efficiency at the level required for mobile device integration, abstraction may only be introduced where its impact on the total average power is sufficiently low or at those places where the resulting extra flexibility can be exploited by improved energy management (targeted flexibility).

Many different architecture styles have already been proposed for SDR. Most of them are designed keeping in mind the important characteristics of wireless physical layer processing: high data level parallelism (DLP) and dataflow dominance. Targeted flexibility and the fact that in wireless systems area can partly be traded for energy efficiency ask for heterogeneous multi-processor system-on-chip (MPSOC) architectures, in which the different tasks of a transmission scheme are implemented on specific engines providing just the necessary performance at minimum cost.

In practice, a radio standard implementation contains, next to modulation and demodulation, functionality for medium access control (MAC) and, in case of burst-based communication, signal detection and time synchronization. The high DLP does not hold for the MAC processing which is, by definition, control dominated and should be implemented separately (e.g. on a RISC). Moreover, packet detection and coarse time synchronization have a significantly higher duty cycle than packet modulation and demodulation.

In contrast, the functionality with high duty cycle usually has relaxed requirements in terms of programmability. The particular functionality of packet detection and coarse time synchronization typically accounts for less than 5% of the total functionality (in terms of source code size). Consequently, the architecture to which the high duty cycle functionality is mapped can be optimized without provision for high-level language programmability (such as, for example, the C language).

Efficient digital signal processing for wireless application with relaxed requirements in terms of programmability typically assumes vector processing. In that vector processing, when an instruction is issued, a similar operation is applied in parallel to operands comprising sets of data elements, so called data vectors. Data elements are also stored in a vector way into the register file.

In many implementations vector processing is combined with scalar processing, where only scalar (namely, single data element) operands are considered (see ‘Vector processing as an enabler for software-defined radio in handsets from 3G+WLAN onwards’, van Berkel et al., SDR Forum Technical Conference, 2004 and ‘Implementation of an HSDPA receiver with a customized vector processor’, Rounioja and Puusaari, SoC2006, November 2006). Two classes of instructions are then used, namely scalar instructions mainly for address calculation and control and vector instructions mainly for computationally intensive tasks. Hence, such a processor should be able to compute scalar and vector instructions in parallel. The approach commonly followed in the prior art employs very large instruction words (VLIW) with separate scalar and vector instruction slots.

The prior art solutions have some important drawbacks. Many different operators such as adders and multipliers are needed to process different instructions in the scalar and vector slots. The utilization of these operators may be very low because only one instruction/slot can be carried out at a time. For more performance the number of slots may be increased. This, though, also increases the number of operators in the design and does not improve their utilization. Moreover, increasing the number of issue slots in a VLIW processor comes at the cost of more expensive instruction fetch and usually requires power-hungry multi-port register files.

When not designed for a specific application (as SDR), VLIW processors are optimized to reduce the number of operators per instruction slot following a pure functional approach. For instance, in a processor with three instruction slots, the first slot can be dedicated to load/store operations, the second to ALU operations and the third, to multiply-accumulate operation. This application-agnostic approach leads however to inefficient operator utilization in case the application has unbalanced utilization statistics of these type of operations.

Contrarily, when (single issue) application specific instruction set processors (ASIP) are optimized, the number of operators is minimized by defining the instruction based on the operation utilization statistics in the targeted application.

Application specific VLIW processor efficiency in terms of operator utilization can be significantly enhanced by generalizing the ASIP optimization approach based on operation profiling not only to the definition of the instruction any more, but also, to the instructions allocation to the multitude of parallel slots.

### SUMMARY OF CERTAIN INVENTIVE ASPECTS

Certain inventive aspects relate to a programmable device comprising a plurality of execution slots with a minimal number of operators with maximized utilization. It also aims to provide a method to optimize the allocation of the instructions to the slots and to schedule and control the instruction flow in order to achieve a dense schedule.

One inventive aspect is related to a programmable device comprising
a scalar portion providing a scalar data path and a scalar register file, whereby the data path and the register file are connected, the scalar portion being arranged for executing scalar instructions,
at least two interconnected vector portions, whereby the vector portions are connected with the scalar portion. Each of the at least two vector portions provides a vector data path and a vector register file connected with each other and is arranged for executing at least one vector instruction different from vector instructions performed by any other vector portion of the at least two vector portions.

In a preferred embodiment the scalar portion and each of the at least two vector portions are provided with a local storage unit for storing several respective instructions.

Preferably the programmable device further comprises a software controlled interconnect for data communication between the vector portions.

Advantageously a first vector portion of the at least two vector portions comprises operators for arithmetic logic unit instructions and a second vector portion comprises multiplication operators.

In another preferred embodiment the programmable device comprises a programming unit for programming arranged for providing the at least one vector instruction.

The programmable device may further comprise a second scalar portion and three interconnected vector portions.

Advantageously each vector register file has three read ports and one write port. Two of the read ports are dedicated to a functional unit. One of the read ports may be arranged for reading between the vector slots. This is referred to as intercluster reading.

In a preferred embodiment all vector instructions executable in a vector portion of the at least two vector portions are different from vector instructions executable in any other vector portion.

In one inventive aspect, the programmable device is advantageously arranged for performing communication according to a standard belonging to the group of standards comprising {IEEE802.11a/g/n, IEEE802.16e, 3GPP-LTE}.

One inventive aspect relates to a digital front end circuit comprising a programmable device as previously described and to a software defined radio comprising such device.

Another inventive aspect relates to a method for automatic design of an instruction set for an algorithm to be applied on a programmable device as above described. The method offers the specific advantage that the static assignment of subsets of the instruction set to a specific slot is optimised. The method comprises:
describing the algorithm in a high-level programming language,
transforming the algorithm into data flow graphs,
performing a profiling to assess the activation of the data flow graphs,
deriving the instruction set based on the result of the profiling,
assigning subsets of the instruction set to the scalar portion and/or the at least two vector portions.
   This approach allows minimizing the number of different instructions per slot and enables a dense schedule based on profiling data extracted in the preceding steps.

Another inventive aspect relates to a method for the packet detection of received data packets. The method comprises analyzing the correlation between data packets with a programmable device as previously described.

### BRIEF DESCRIPTION OF THE DRAWINGS

FIG. 1 represents a synchronization algorithm for the IEEE802.11a standard.

FIG. 2 represents an IEEE802.11a synchronization peak.

FIG. 3 represents a vector accumulation.

FIG. 4 represents a programmable device according to one embodiment.

FIGS. 5 to 9 represent the functionality of software controlled interconnect.

### DETAILED DESCRIPTION OF CERTAIN ILLUSTRATIVE EMBODIMENTS

Certain embodiments relate to an instruction set processor adapted for signal detection and coarse time synchronization for integration into a heterogeneous MPSOC platform for SDR. The tasks of signal detection and coarse time synchronization have the highest duty cycle and dominate the standby power. One application of certain embodiments concerns the IEEE 802.11a/g/n and IEEE 802.16e standards, where packet-based radio transmission is implemented based on orthogonal frequency division multiplexing or multiple-access (OFDM(A)). Certain embodiments are further explained using this example, but it is clear to any skilled person that it is just an example that in no way limits the scope of the present invention. The main design target is energy efficiency. Performance must be just sufficient to enable real time processing at the rates defined by the standards. In order to take provision for future standards such as 3GPP-LTE, an application specific instruction-set processor (ASIP) approach is preferred, as in that way the best energy/efficiency trade-off can be achieved.

For applications with sufficient data parallelism, a VLIW ASIP processor architecture is proposed with at least one scalar and at least two vector instruction slots. In our example some (at least one) of the vector slots contain operators for ALU instructions and some (at least one) other(s) contains multiplication operators. The ratio between ALU and multiplication operators should be adapted to the ratio of such operations in the target application domain. Usually more than one ALU operator is then desirable and, in that case, the instruction set architecture (ISA) of all additional ALUs is customized to the specific operations that are occurring in the target application (based on profiling experiments consisting of simulating the execution of representative benchmark program on a instruction set accurate model of the processor).

The additional cost for loading more operands in parallel is reduced by clustering instruction slots with operators and register files. In a preferred embodiment communication between clusters is done with a software controlled interconnect that provides almost the flexibility of a big multi-port register file, but at far less power. More details on this are provided in the paper ‘Register organization for media processing’, Rixner et al., January 2000, HPCA, pp. 375-386.

To reduce the overhead for the more expensive instruction fetch, separate loop buffers and controllers for scalar and vector instructions are proposed, potentially even within the clusters of the vector operators. In that way it is allowed filling the issue slots even better, because the control flow of the different clusters does not need to be the same any longer: every cluster can have its own control flow and still it is derived from the same shared program stored in the program memory.

For energy-aware implementation special attention must be paid to the selection of the instruction set, parallelization, storage elements (register files, memories) and interconnect. Each of these topics is addressed more in detail below.

### Instruction Set Selection

Usually, ASIP design starts with a careful analysis of the targeted algorithms. A flow is applied where profiling is performed on the application to define, partition and assign the instruction set to the several parallel, clustered instruction sets. Therefore, in a first step, the targeted algorithms must be described in a high-level language such as C. These algorithms are then transformed into data flow graphs and executed using random stimuli sets representative of the application. Thereby, the parts of the data-flow graphs which are activated often, can be identified. Afterwards, in a semi-automatic way, special instructions are defined and introduced to the algorithm in form of intrinsic functions. The granularity of the special instructions depends on the targeted technology and clock frequency.

After the instruction set has been defined, a dimensioning, partitioning and allocation step is carried out. Therefore, the algorithms, including the newly defined intrinsic functions, are executed in order to collect activation statistics. Based on the statistics, the dominant operations are identified (based on a user-defined threshold). Based on the obtained information the operators are then grouped or replicated per operator group such that

(1) the number of different instructions per slot is minimized, thereby minimizing the number of operator types and total operators,

(2) a denser schedule is made feasible by ensuring that the operation sequence (including the data dependencies) has limited holes, and

(3) those sequences (per operator group) have a critical path lower than the real-time constraint. This can be automated, because the target clock rate is known.

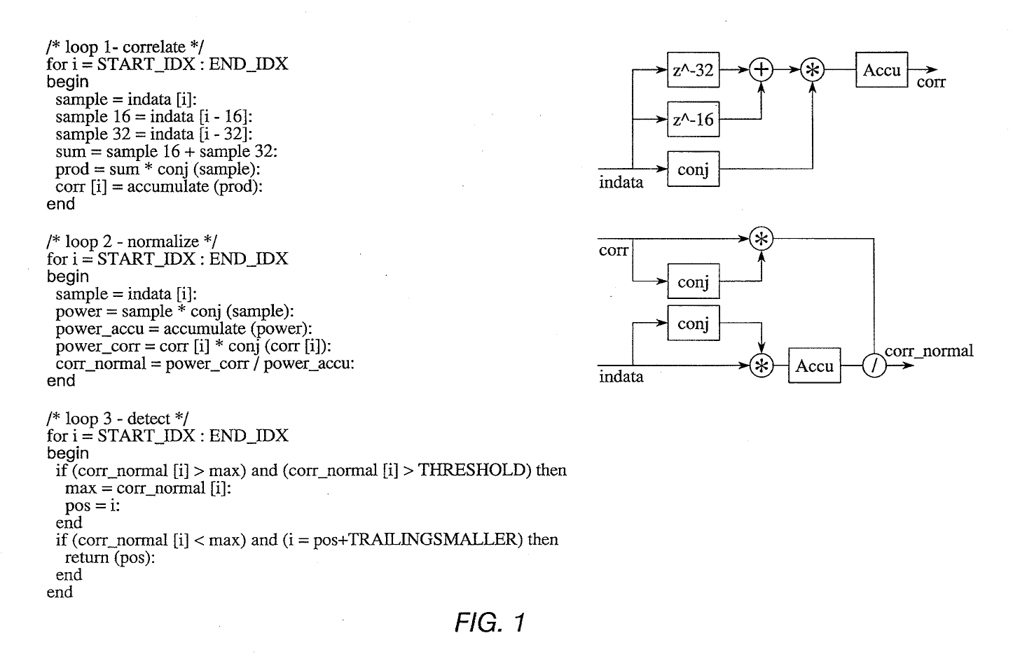

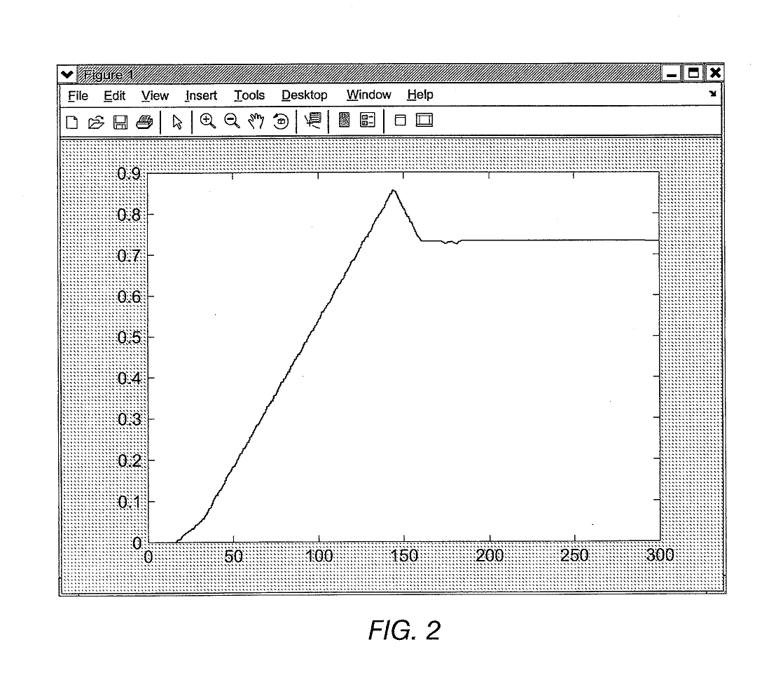

FIG. 1 illustrates the typical structure of a synchronization algorithm in the example of IEEE802.11a. The code mainly consists of three loops. In the first two of them, the correlation in the input signal is explored. Here significant DLP is present that can be efficiently exploited by vector machines. In the third loop, one scans for a peak in the correlation result and compares it to a threshold. This is a more control oriented task. It can also be seen that a number of input samples (correlation window) needs to be stored in memory. FIG. 2 illustrates the resulting synchronisation peak.

The code for IEEE802.16e shows very similar characteristics. Moreover, many common computational primitives can be identified, which suits the followed ASIP approach. However, compared to the IEEE802.11a synchronization, the algorithms for IEEE802.16e are far more computationally intensive (191 operations/sample on average vs. 82 op/sample for IEEE802.11a). In terms of throughput both applications are very demanding (up to 20 Msamples/s).

Translation of floating point code in fixed point code with limited precision (fixed-point refinement) shows that all computations for IEEE802.11a and IEEE802.16e can be done within 16 bit signed precision. Moreover, all divisions can be removed by algorithmic transformations. The code is optimized, including merging of the kernels into a single loop to improve data locality and reduce control. Afterwards, the code is vectorized and mapped to a number of pragmatically selected primitives. An instruction set can then be derived. Complex arithmetic is preferably implemented in hardware because all computations are on complex samples. This proves very efficient for SDR processing.

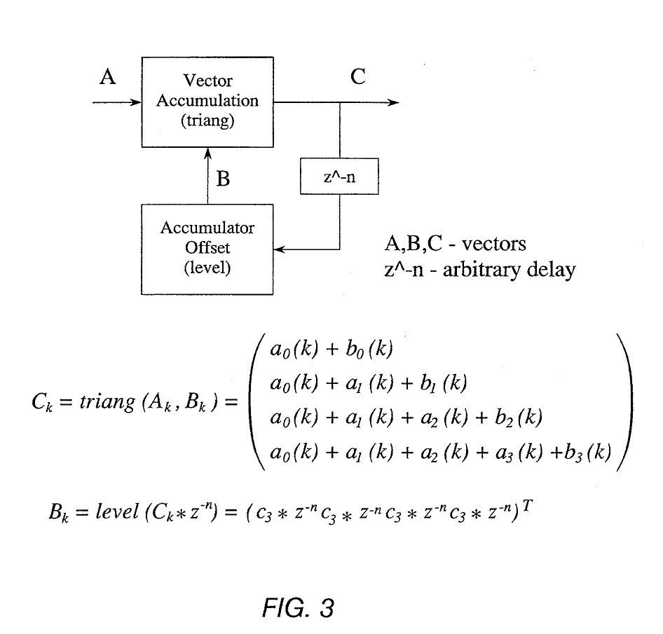

In the specific targeted application a specific challenge is the development of a mechanism for vector accumulation. In the example the detection of the synchronization peak must be sample accurate. Hence, all correlation outputs need to be evaluated. Therefore, in a preferred embodiment, a scheme is introduced that preserves the intermediate results of a vector accumulation (triang, level—see FIG. 3) and instructions to extract maxima from vectors (rmax/imax).

### Parallel Processing

In-order VLIW machines with capabilities for vector processing are most energy efficient for SDR. After the instruction set definition one has to decide about the amount of parallel processing needed to guarantee real-time performance at minimum energy cost.

First a target clock is derived. In our example the maximum achievable clock rate is limited to 200 MHz by the selected low power memory technology. The program and data memories are intended to read and write without multi-cycle access or stalling the processor. Next, instruction and data-level parallelism are analyzed. From the application it is observed that control and data processing can easily be parallelized. This yields separate scalar and vector slots. Since DLP is largely present in the algorithms for signal detection and coarse time synchronization, the amount of vectorization is decided first. Assuming a processor with a single vector slot and a clock rate of 200 MHz, a vectorization factor (number of complex data elements per vector) of at least 4.5 would be needed to process a perfect (i.e. without holes) schedule of the most demanding application real-time (IEEE802.16e at 20 MHz input rate). A schedule with close to optimal operator utilisation is made possible, for a vectorization factor of 4, by using multiple vector slots with orthogonal (non-overlapping) instruction set. This also guarantees maximum utilization of the operators. Hence, performance and energy efficiency can be improved without adding additional operators by distributing the instruction set over multiple scalar and vector slots in an orthogonal (non-overlapping) way. Highest efficiency can be achieved by distributing the instruction set according to the instruction statistics of the applications. In some specific examples the ratio of vector operations to scalar operations is 46/28 in the IEEE802.16e and 23/16 in the IEEE802.11a kernel. Accordingly, the target architecture should ideally be able to process 3 vector and 2 scalar operations in parallel. The design is therefore partitioned in three vector and two scalar instruction slots.

FIG. 3 shows the micro-architecture and the distribution of the instruction set derived in the example. The instructions in the scalar slots operate on 16 bit signed operands, the instructions in the vector slots on four complex samples in parallel (128 bit). It is intuitive that further vectorization (256 bit or 512 bit) will lead to larger complexity in the interconnection network.

### Clustered Register Files and Interconnect

A shared multi-ported register file is typically a scalability bottleneck in VLIW structures and also one of the highest power consumers. Therefore, a clustered register file implementation is preferred.

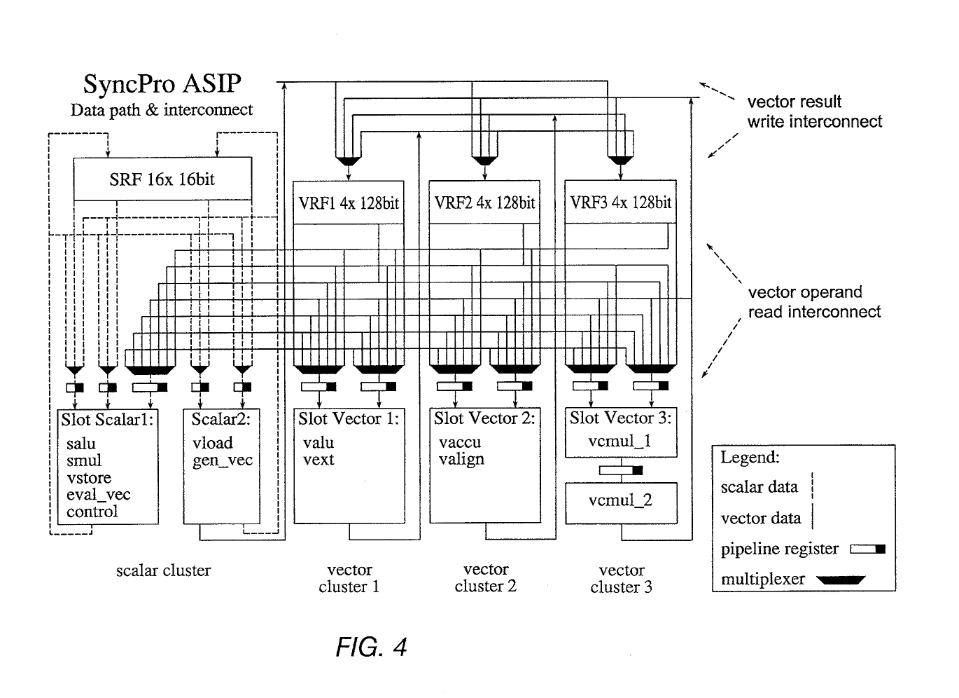

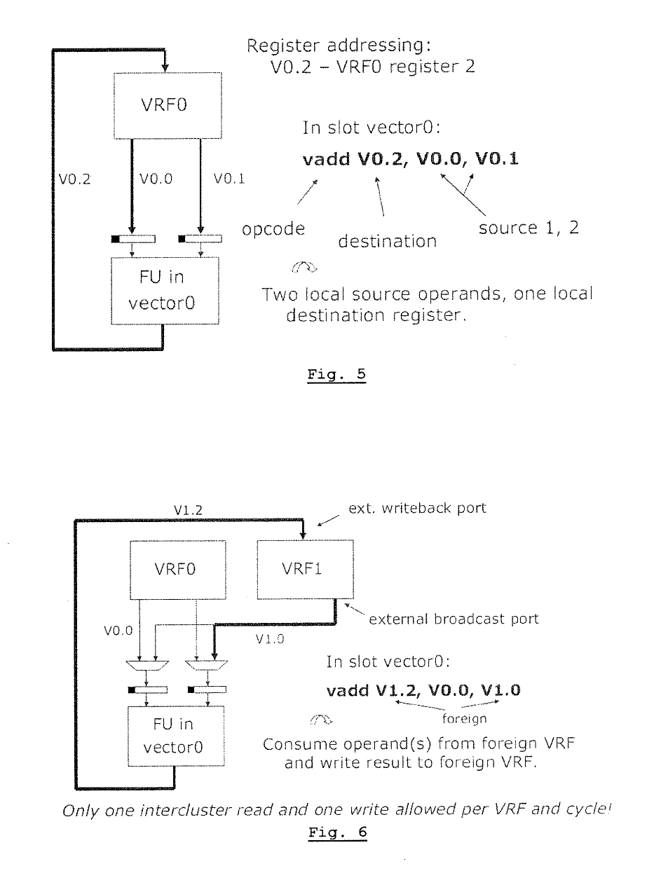

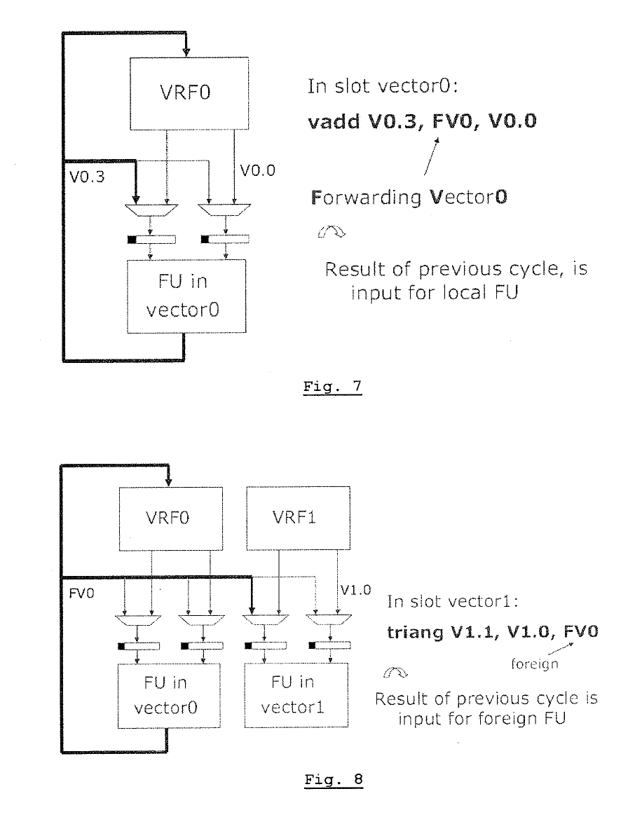

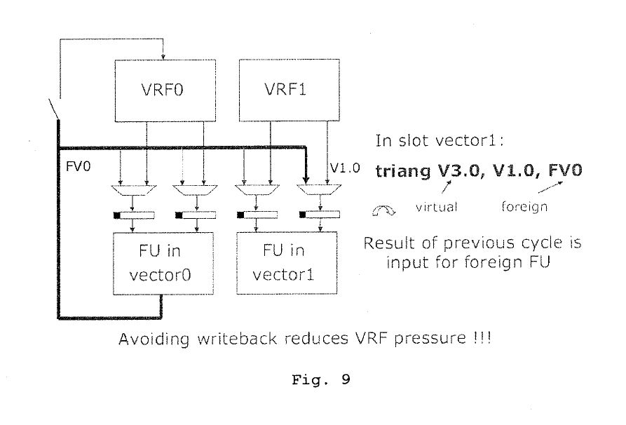

As shown in FIG. 4, in the above-mentioned specific example, four general purpose register files are implemented. The scalar register file (SRF) contains 16 registers of 16 bit and has 4 read and 2 write ports. Because of its small word width, the costs of sharing it amongst the functional units (FUs) in the two scalar slots is rather low. The vector side of the processor is fully clustered. Each of the three vector register files (VRF) holds 4 registers of 128 bit and has 3 read and 1 write port. Two of the read ports are dedicated to the FUs in a particular vector slot (FIG. 5). The third one is used for operand broadcasting (intercluster read—FIG. 6) and can be accessed from all the other clusters, including the scalar cluster (vector evaluation, vector store). Routing the vector operands is done via a vector operand read interconnect. Because each VRF has only one broadcast port, only one intercluster read per VRF can be carried out per cycle. The vector operand read interconnect also enables operand forwarding within and across vector clusters (FIGS. 7,8). Due to this flexibility, the result of any vector instruction can be directly used as input operand for any vector instruction in any vector cluster in the following cycle. The software controlled interconnect also allows disabling the register file writeback of any vector instruction. That way, computation results which are directly consumed in the following cycle do not need to be stored and pressure on the register files is reduced (allocation, power). The vector result write interconnect is used to route computation results to the write ports of the VRFs.

Each VRF write port can be written from all vector slots and from FUs in slot scalar2 (generate vector, vector load). The programmer is responsible to avoid access conflicts. The selected interconnect provides almost as much flexibility as a central register file, but at a lower energy cost.

In a preferred embodiment a data scratchpad is implemented. In order to share interconnect, vector load and vector store are implemented in different units. The load FU is connected to the first scalar slot, which is capable of writing vectors. The store FU is assigned to the second scalar slot, from which vector operands can be read (FIG. 4). To ease platform integration, the processor may provide a number of direct I/O ports, for example, a blocking interface for reading vectors from an input stream.

Given the described architecture and the target technology, it is then required to decide on the amount of pipelining that is needed to reach the targeted clock rate and seamlessly interface the instruction and data memory.

In a preferred embodiment a pipeline model is derived with two instruction fetch (FE1, FE2) and one instruction decode (DE) stage. Additionally, the units in the scalar slots and in the first and second vector slot have one execution stage (EX). The complex vector multiplier FU in the third vector slot has two execution stages (EX, EX2).

The FE1 stage implements the addressing phase of the program memory. The instruction word is read in FE2. In stage DE, the instruction is decoded and the data memory is addressed. The decoder decides which register file ports need to be accessed. Routing, forwarding and chaining of source operands are fully software controlled. Source operands are saved in pipeline registers at the end of DE and consumed by the activated FUs in the following cycle. Register files are written at the end of EX (or EX2).

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

1. A programmable device comprising:
a scalar portion providing a scalar data path and a scalar register file and configured to execute scalar instructions; and
at least two interconnected vector portions, the vector portions being connected with the scalar portion, each of the at least two vector portions providing a vector data path and a vector register file and configured to execute at least one vector instruction different from vector instructions performed by any other vector portion of the at least two vector portions.

2. The programmable device of claim 1, wherein the scalar portion and each of the at least two vector portions are provided with a local storage unit configured to store respective instructions.

3. The programmable device of claim 1, further comprising a software controlled interconnect for data communication between the vector portions.

4. The programmable device of claim 1, wherein a first vector portion of the at least two vector portions comprises operators for arithmetic logic unit instructions and wherein a second vector portion comprises multiplication operators.

5. The programmable device of claim 1, further comprising a programming unit configured to provide the at least one vector instruction.

6. The programmable device of claim 1, further comprising a second scalar portion, wherein the at least two interconnected vector portions comprise three interconnected vector portions.

7. The programmable device of claim 1, wherein each vector register file comprises three read ports and one write port.

8. The programmable device of claim 7, wherein at least two of the read ports are dedicated to a functional unit in the vector datapath.

9. The programmable device of claim 7, wherein at least one of the read ports is arranged for reading between the vector slots.

10. The programmable device of claim 1, wherein all vector instructions executable in a vector portion of the at least two vector portions are different from vector instructions executable in any other vector portion.

11. The programmable device of claim 1, wherein the device is configured to perform communication according to a standard belonging to the group of standards comprising IEEE802.11a/g/n, IEEE802.16e, and 3GPP-LTE.

12. A digital front end circuit comprising the programmable device of claim 1.

13. A software defined radio terminal comprising the programmable device of claim 1.

14. A method of automatically designing an instruction set for an algorithm on the programmable device of claim 1, comprising:
describing the algorithm in a high-level programming language;
transforming the algorithm into data flow graphs;
performing a profiling to assess activation of the data flow graphs;
deriving an instruction set based on the result of the profiling; and
assigning subsets of the instruction set to the scalar portion and the at least two vector portions such that the number of instructions per slot is minimized.

15. A method of detecting received data packets, the method comprising analyzing the correlation between received data packets with the programmable device of claim 1.

16. A programmable device comprising:
means for executing scalar instructions, the scalar instruction executing means providing a scalar data path and a scalar register file; and
means for executing vector instructions, the vector instruction executing means comprising at least two interconnected vector portions, the vector portions being connected with the scalar instruction executing means, each of the at least two vector portions providing a vector data path and a vector register file and configured to execute at least one vector instruction different from vector instructions performed by any other vector portion of the at least two vector portions.

17. The programmable device of claim 16, wherein the scalar instruction executing means and each of the at least two vector portions are provided with means for storing respective instructions.

18. The programmable device of claim 16, further comprising a software controlled interconnect for data communication between the vector portions.

19. The programmable device of claim 16, wherein a first vector portion of the at least two vector portions comprises operators for arithmetic logic unit instructions and wherein a second vector portion comprises multiplication operators.

20. The programmable device of claim 16, further comprising means for providing the at least one vector instruction.

21. The programmable device of claim 1, wherein each vector register file has only one read port for operand broadcasting among the vector portions.
